(19) United States
(12) Patent Application Publication
(10) Pub. No.: US 2022/0234792 A1
(43) Pub. Date: Jul. 28, 2022

(54) DUAL OPENING DISPENSING PACKAGE

(71) Applicants: Mounib Fares Aoun, Raleigh, NC (US); James Gordon Passe, Raleigh, NC (US)

(72) Inventors: Mounib Fares Aoun, Raleigh, NC (US); James Gordon Passe, Raleigh, NC (US)

(21) Appl. No.: 17/720,921

(22) Filed: Apr. 14, 2022

Related U.S. Application Data
(63) Continuation-in-part of application No. 15/914,649, filed on Mar. 7, 2018, now abandoned.

(51) Int. Cl. B65D 47/12; B65D 77/20; B65D 85/72; B65D 47/36; A23L 27/60

(52) U.S. Cl. CPC B65D 47/12; B65D 77/2032; B65D 85/72; A23V 2002/00; A23L 27/60; A23L 27/63; B65D 2577/205; B65D 47/36

(57) ABSTRACT

A dual opening single use package for dispensing a thickened product wherein, in one position, the package can be squeezed to remove the thickened food product but also can be opened for full access to the thickened food product, such as for dipping french fries in ketchup.

This application is a continuation-in-part of US non-provisional application Ser. No. 15/914,649 filed on Mar. 7, 2018 and is incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a dual opening dispensing package. In particular, it relates to a package that is resealable and can be fully opened for dipping or in the alternative, is also capable of having a metered opening.

### Description of Related Art

The containment of products such as foodstuff, body care products, cosmetics, perishable products, and the like in small containers, especially single serve, is well known. These products are normally flowable, and thickened compared to water and are in a squeezable container with a metered opening, like toothpaste. These products include liquids, gels, and thickened or thick flowable products. Examples of such substances include milk; yogurt, honey, jam, peanut butter, chocolate spread, dips, mayonnaise, ketchup, mustard, liquid soap, shampoo, hair conditioner, makeup; and the like. It is known that these products are increasing in popularity, especially the single serve/one person use type packages.

Frequently there is a need as well, to be able to open the package completely to gain access to the contents all at once deeming a metered opening impractical. One example is ketchup packages which can be sealed tubs which; when opened, allow for the dipping of french fries. Yet, also available are ketchup packages with a tear end which are designed for squeezing the ketchup out where a user can't dip their french fries. Frequently, there is a need to reseal the opened package if the contents are not entirely used and there are very few options in the way of solutions for resealing single use packages. One approach to provide both full and metered access is shown in U.S. Pat. Nos. 7,703,619 and 8,403,161 where a single layer top can be torn off in which a user has access to a complete opening, wherein at one end, a fracture line is created in the base which breaks and opens the end of a channel molded into the end of the package where ketchup can be dispensed out of a metered opening. Some problems exist with this approach, however. The first problem being that the manufacture of both a channel and a fracture line extends out from the base. Additionally, the lid is extremely expensive and complicated to manufacture when compared to a simple package of the other available containers. Secondly, the package must be made of a stiff plastic to allow the fracture line to operate properly, making the package difficult to squeeze in order to get the product out of the metered opening. Thirdly, this type of metered opening is difficult to open and once the metered opening has been fractured along the fracture line, the package cannot be resealed easily, if at all.

Being able to provide an effective dual opening single use small package for dispensing a thickened product without the above and other problems, is still needed.

### BRIEF SUMMARY OF THE INVENTION

The present invention relates to the discovery that a multi-piece peel off lid can be utilized which allows for a choice of either full opening of the package and access to the thickened product, or the opening of a package capable of allowing a metered flow of a product. In one embodiment, either the metered or full opening, or both, can be resealed.

Accordingly, in one embodiment, there is a single use package for dispensing a thickened product comprising:
a) a shell having a top, a bottom, and a side which defines a cavity for containing the thickened product, the shell having a flat upper circumferential lip at the top of the shell and a single hole positioned in the side of the shell and sized to pass the thickened product upon squeezing the shell; a first shell completely removable adhesive closure comprising a top layer which entirely covers the cavity by only directly attaching to the entire flat upper circumferential lip, wherein the first shell completely removable adhesive closure has a first tab to aid in removing the first shell completely removable closure;
b) a second shell completely removable adhesive closure separate from and not attached to the first shell completely removable adhesive closure comprising a flat layer with a second tab for horizontal removal of the second shell completely removable adhesive closure positioned directly below and on the same side as the first tab of a size for entirely closing the single hole in the shell, which when the second shell completely removable adhesive closure is removed horizontally from the shell using the second tab, it uncovers the single hole for metered dispensing by squeezing the shell, wherein the second shell completely removable adhesive closure does not extend past the bottom of the shell sides; and
c) wherein the first shell completely removable adhesive closure can be completely removed from the shell to provide an opening to the cavity without disturbing the second shell completely removable adhesive closure, and wherein the second shell completely removable adhesive closure can only be completely removed horizontally from the side of the second shell completely removable adhesive closure without disturbing the first shell completely removable adhesive closure.

### BRIEF DESCRIPTION OF THE DRAWINGS

FIG. 1 is an exploded view of an embodiment of the present invention.

FIG. 2 is a perspective view of the embodiment of FIG. 1.

### DETAILED DESCRIPTION OF THE INVENTION

While this invention is susceptible to embodiment in many different forms, there is shown in the drawings and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment,” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “package” refers to a container for holding a certain amount of a thickened product for use either all at once or in a metered fashion. It can be a large package or a single unit package, such as a single use ketchup package. The package will have both a complete opening for access to the product cavity all at once and a metering hole for access to the product in a metered way by squeezing the package, such that product flows out of the metering hole. The package can be made of any material known in the art, either stiff or flexible, as desired.

As used herein, the term “thickened product” refers to any product normally flowable, though thickened, if in a squeezable container with a metered opening like toothpaste. They include liquids, gels, and thickened or thick flowable products. In one embodiment, they are food products. Examples of such substances include milk, yogurt, honey, jam, peanut butter, chocolate spread, mayonnaise, ketchup, mustard, liquid soap, shampoo, hair conditioner, makeup, and the like. It is clear that the thickened product must be chemically compatible with the shell and closure materials selected. That selection is within the skill in the art in view of the disclosure herein.

As used herein, the term “shell” refers to a portion of the package which defines a cavity for containing the thickened product. It will have a lip which is positioned wholly circumferentially at a top portion of the shell, and is essentially in the same plane, as shown in the figures. In one embodiment, the shell has a bottom and sides which define the circumference of the shell. The circumferential lip is positioned on the top of the sides of the shell. In one embodiment, the shell is made of a flexible polymeric or paper material.

As used herein, the term “cavity” refers to a space in the shell designed to hold the given amount of thickened product. The shape of the cavity can be anything within the parameters of the construction of the package including tubular, cube like, rectangular, and the like. In one embodiment, it includes the shape shown in the figures.

As used herein, the term “circumferential lip” refers to the top edge of the shell, and flat all in the same plane, that is used to adhere a closure on the closures circumference.

As used herein, the term “first shell closure” refers to a flexible material used to attach to the shell to close and provide storage of the product in the package. It refers to a generally flexible material which entirely covers the cavity by attaching (e.g., by adhesive, either reusable or not) to the circumference or a portion of the circumference of the lip of the shell to provide a cover over the cavity or a cover on the bottom layer. The closure must be flat to match the flat circumferential lips. The figures go into more detail and one skilled in the art can utilize generally accepted principles to choose materials and adhesives. The top layer can have a tab for aiding in removal of the top layer in the normal manner.

As used herein, the term “hole for metered dispensing” refers to a hole in the side of the shell of a size that when the shell is squeezed, product can flow out the hole. In general, it can be from about inch to ½ inch in diameter; however, the size can depend on the size of the shell and the flowability of the product.

As used herein; the term “resealable” refers to selection of an adhesive which allows the first or second shell closure to reseal the cavity or hole, respectively. Such adhesives are well known in the art.

As used herein, the term “second shell closure” refers to a closure for covering and sealing the metering hole in the side of the shell. It can be single use or resealable. It is attached by an adhesive and is removable horizontally. It is not attached to the first closure in any manner. In using the package, a user can remove the top layer for access to the cavity.

### DRAWINGS

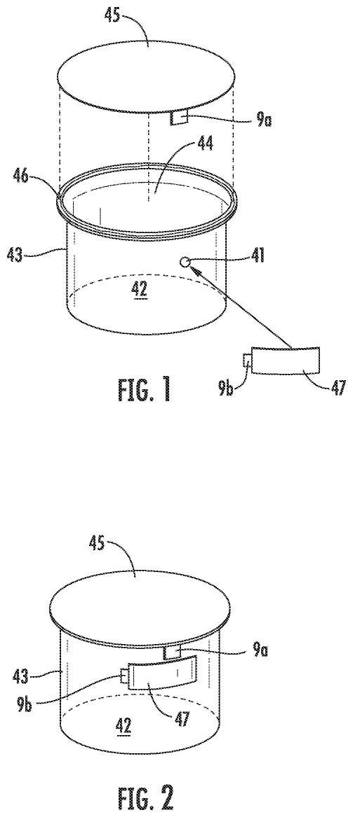

FIG. 1 is an exploded view of an embodiment of the present invention. In this embodiment, we can see that the dispensing hole 41 is in the side wall 42 of shell 43 with cavity 44. In this view, a first flat shell closure 45 is attached to flat shell circumferential lip 46. In this embodiment, first flat shell closure 45 has a tab 9a for aiding in removal of the first flat shell closure 45. A second shell closure 47 is positioned directly below the first flat closure 45 and on the same side as the first flat shell closure 45. The positioning is such that removal of the second shell closure 47 is horizontal so its removal will not accidentally open the first flat shell closure 45. The second shell closure 47, not attached to the first flat shell closure 45, is utilized and attached to sidewall 42 and covers dispensing hole 41. The second shell closure 47 can only be removed horizontally using tab 9b and is a removable adhesive strip. By removal of either the first flat shell closure 45, by using tab 9a, or second shell closure 47, by using tab 9b, a user can access the complete opening or the metered opening, respectively.

FIG. 2 is a perspective view of the sealed package of FIG. 1 of the present invention.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A single use package for dispensing a thickened product comprising:
a) a shell having a top, a bottom, and a side which defines a cavity for containing the thickened product, the shell having a flat upper circumferential lip at the top of the shell and a single hole positioned in the side of the shell and sized to pass the thickened product upon squeezing the shell; a first shell completely removable adhesive closure comprising a top layer which entirely covers the cavity by only directly attaching to the entire flat upper circumferential lip, wherein the first shell completely removable adhesive closure has a first tab to aid in removing the first shell completely removable closure;
b) a second shell completely removable adhesive closure separate from and not attached to the first shell completely removable adhesive closure comprising a flat layer with a second tab for horizontal removal of the second shell completely removable adhesive closure positioned directly below and on the same side as the first tab of a size for entirely closing the single hole in the shell, which when the second shell completely removable adhesive closure is removed horizontally from the shell using the second tab, it uncovers the single hole for metered dispensing by squeezing the shell, wherein the second shell completely removable adhesive closure does not extend past the bottom of the shell sides; and
c) wherein the first shell completely removable adhesive closure can be completely removed from the shell to provide an opening to the cavity without disturbing the second shell completely removable adhesive closure, and wherein the second shell completely removable adhesive closure can only be completely removed horizontally from the side of the second shell completely removable adhesive closure without disturbing the first shell completely removable adhesive closure.

2. The single use package for dispensing a thickened product according to claim 1, wherein the food product is the thickened product consisting of a food product selected from at least one of the group consisting of mayonnaise, mustard, and ketchup for metered dispensing of the thickened product; and

3. The single use package for dispensing a thickened product according to claim 1, wherein the first shell completely removable adhesive closure is made of a flexible, polymeric, or paper.
